(19) United States
(12) Patent Application Publication
(10) Pub. No.: US 2002/0134837 A1
(43) Pub. Date: Sep. 26, 2002

(54) Method and apparatus for electronically exchanging data

(76) Inventor: Jakob Kishon, Pleasanton, CA (US)

Correspondence Address: Elaine H. Lo, SKJERVEN MORRILL MacPHERSON LLP, Suite 700, 25 Metro Drive, San Jose, CA, 95110-1349, US

(21) Appl. No.: 09/947,246

(22) Filed: Sep. 5, 2001

Related U.S. Application Data
(60) Provisional application No. 60/263,597, filed on Jan. 23, 2001.

(51) Int. Cl. G06K 7/08

(52) U.S. Cl. 235/449

(57) ABSTRACT

A magnetic head assembly includes a magnetic head and a chip including an amplifier. The magnetic head and chip may be mounted on a multi-chip module substrate and packaged in a mechanical enclosure to form a single module. The chip of the magnetic head assembly may include a microcontroller with electronic circuitry for processing the information from a magnetic stripe and transmitting the information to a host. The microcontroller may further include electronic circuitry for interfacing with and processing information from a smart card. This compact module can electronically exchange information contained in a magnetic stripe and/or smart card. A web-based depository for storing and business card information and creating electronic business cards is also disclosed.

### FIELD OF THE INVENTION

The present invention relates generally to methods for retrieving and manipulating data gathered by magnetic stripe media. More particularly, the present invention relates to a compact module capable of retrieving and processing data contained on a magnetic stripe.

### BACKGROUND

Magnetic stripe media (MSM), such as credit cards and security cards, are a common part of our lives. Using a magnetic reader is a very simple and familiar process. The card or other MSM is presented to the magnetic reader and the magnetic stripe is swiped across the reader, which electronically reads the information contained on the magnetic stripe.

Today's business are concentrating their efforts to increase sales through use of the Internet. Some businesses, however, cannot sell their products online. Instead, these businesses provide for automated electronic transactions where their products are sold. On-the-spot transactions are made possible by the use of magnetic card readers, which read the information contained on the magnetic stripe of a credit, debit, or ATM card. In order to obtain information from the magnetic card, the magnetic card readers expect the magnetic stripe to contain specially formatted data. The data is typically divided into three separate tracks along the magnetic stripe. The format is defined by ISO/IEC-78 11, which uses a 6-bit format (with one parody bit) to define all pertinent information necessary to make secure electronic transactions.

One main problem with conventional magnetic card readers is their size. These magnetic card readers have many individual components, are rather large, and cannot be easily incorporated into portable devices without substantially increasing the size of the portable device. In addition, these readers are limited to magnetic stripes and cannot retrieve information contained on smart cards or other non-magnetic media. Thus, it would be desirable to provide a compact module capable of retrieving information contained on a magnetic stripe and/or smart card.

Another problem for magnetic card readers is knowing, once a card is inserted, where exactly the data begins and ends and how fast the card is moving. This is accomplished by designating a portion of the magnetic stripe as start and stop bits, which the magnetic card reader recognizes as starting and ending points with valid magnetic data on the stripe in between. In addition, the magnetic stripe area includes encoder markings located at fixed intervals. The encoder markings allow the magnetic card reader to read the data at appropriate intervals. This is important, since no two cards will be swiped across a magnetic card reader either in the same amount of time or at a constant speed.

Thus, there is a need for a more compact magnetic card reader, which detects where the magnetic data starts and stops and which determines how fast the card is moving.

### SUMMARY

The present invention provides a compact module capable of retrieving information contained on a magnetic stripe and/or a smart card. The small size of the module enables it to be easily integrated into portable devices, such as personal digital assistants (PDAs) or cellular phones.

In accordance with one embodiment of the invention, a magnetic head assembly includes a magnetic head and a chip. The magnetic head includes a housing having an opening formed therein. The chip, which includes an amplifier, is disposed in the opening of the housing. The magnetic head assembly may further include a multi-chip module substrate, to which the magnetic head and chip are electrically connected. One advantage of this embodiment over the prior art is its compact size, which enables the magnetic head assembly of the present invention to be incorporated into smaller and portable devices. Thus, the present invention enables the use of magnetic stripe media in areas not currently used today. In addition, the magnetic head assembly of the present invention reduces noise and has a high level analog signal output. This is achieved by cutting down on the connection between the magnetic head and the amplifier.

In accordance with another embodiment of the invention, an improved magnetic stripe reader includes a magnetic head and a chip as described above. The chip further includes a microcontroller, which contains electronic circuitry for processing information from a magnetic stripe. The microcontroller receives the magnetic stripe information from the magnetic head, via the amplifier, and transmits the information in electronic form to a host. The microcontroller may further include electronic circuitry for interfacing with and processing information from a smart card. In addition, the magnetic stripe reader may include a Trusted Computing Platform Alliance (TCPA)-compliant controller for encryption and security.

In accordance with still another embodiment of the invention, a device for reading information from a magnetic stripe includes a printed circuit board and a magnetic stripe reader assembly. The magnetic stripe reader assembly, which is mounted to the printed circuit board, includes a magnetic head and a chip. The chip is disposed in an opening of the magnetic head housing. The chip includes an amplifier and a microcontroller for receiving, processing, and transmitting information from the magnetic stripe. The magnetic stripe reader assembly may further include a multi-chip module substrate, to which the magnetic head and chip are mounted and electrically connected, and a mechanical enclosure encasing the magnetic head and chip to form a single module.

The present invention, by reducing the size of a magnetic stripe reader module, facilitates the use of MSM in other applications, such as, for example, a business card with a magnetic stripe on the back. Such a business card can be a paper business card with printed information on the front and an electronically readable format on the back. This hybrid business card, the eBiz-card, can be used in place of a normal business card. In addition, the information contained on this eBiz-card can be read electronically by swiping the eBiz-card across a magnetic strip reader.

Thus, in accordance with still another embodiment of the invention, a sophisticated database management web-based depository for collecting and managing the information listed on the eBiz-card is provided. The method includes accessing a depository over a network and entering information into the depository. The information may include a user's first and last name, title, company and address, telephone and facsimile numbers, and email address. The method further includes storing the information in the depository, formatting the information in an electronic format, and printing a business card. The front of the business card has the user-entered information printed thereon, while the back of the business card includes a magnetic stripe containing the information in the electronic format. As a member of the depository, the user can access the information and update it as necessary (e.g., new phone number, email address, etc.). Once the information is updated, the user can then order new eBiz-cards. An embodiment of the present invention will include paper printers with magnetic writing capabilities.

Handing out eBiz-cards guarantees that the recipient will have all of the relevant information in electronic format (e.g., regular and email addresses, web-site, phone numbers, etc.). The electronic format includes start-of-text and end-of-text characters, with a plurality of text fields located therebetween. A format code is located after the start-of-text character, and group and field characters separate the plurality of text fields. When the recipient swipes the eBiz-card across a magnetic strip reader in his/her PDA, the text information will be entered automatically into the personal information manager (PIM) application, such as Outlook or Novel.

As discussed above, the present invention is also capable of retrieving and manipulating information contained in a smart card. In Europe smart cards are very popular, however, in the United States they are almost nonexistent. Smart cards will increase in market share as more credit card companies adopt them (see: http: /www18.americanexpress.com/BlueForBusiness/card_reader_types.asp#key board).

### BRIEF DESCRIPTION OF THE DRAWINGS

FIG. 1 is a schematic diagram illustrating a connection between a Smart-Head magnetic stripe reader and a host.

FIG. 2 is schematic diagram illustrating the components of the Smart-Head magnetic stripe reader of FIG. 1 and possible additions to the reader.

FIG. 3 is a top plan view of one embodiment of a magnetic head assembly for the magnetic stripe reader of FIGS. 1 and 2.

FIG. 4 is a cross-sectional view taken generally along the line 4-4 of FIG. 3.

FIGS. 5A-5F illustrate the sequence for assembling the magnetic stripe reader of FIGS. 1 and 2.

FIGS. 6A-6C are a top and two side views, respectively, of the magnetic stripe reader in a PBGA package.

FIGS. 7A-7C are top, side and bottom views, respectively, of the magnetic stripe reader in a DIP package.

FIGS. 8A-8C are a top and two side views, respectively, of the magnetic stripe reader in a SOIC package.

FIG. 9 is an exploded perspective view of another embodiment of the magnetic stripe reader.

FIG. 10 is a partial view of a magnetic card having a multi-track magnetic stripe.

FIG. 11 is a top plan view of three magnetic head assemblies stacked together.

FIG. 12 is a schematic diagram illustrating a connection between a Combo-Reader magnetic strip reader and a host.

FIG. 13 illustrates a typical ISO 7816-2 pin arrangement for a smart card.

FIG. 14 is a perspective view of a typical smart card connector assembly.

FIG. 15 is schematic diagram of one embodiment of a SIM Reader.

FIG. 16 illustrates a relationship between user data entry and a resulting eBiz-card.

FIG. 17 illustrates a variable string data format for the eBiz-card.

FIGS. 18A-18C are plan views of several portable devices that can incorporate the present invention.

FIG. 19 is a plan view of a desktop keyboard that can incorporate the present invention.

FIGS. 20A and 20B are examples of other magnetic-paper media having a magnetic stripe, with which the present invention can operate.

### DETAILED DESCRIPTION

A compact magnetic stripe reader, herein referred to as the “Smart-Head magnetic stripe reader,” has been created for incorporation into portable devices. Unlike conventional magnetic card readers, which are larger and have many individual components, the Smart-Head magnetic stripe reader is a fully functional magnetic stripe reader in a single component or module. This magnetic stripe reader utilizes multi-chip module (MCM), multi-chip package (MCP), or other components that are combined to form a single component or module. Accordingly, the Smart-Head magnetic stripe reader has a low profile and provides a low power module assembly that is suitable for portable device applications (e.g. PDAs, pocket-PCs, cellular phones, and keyboards).

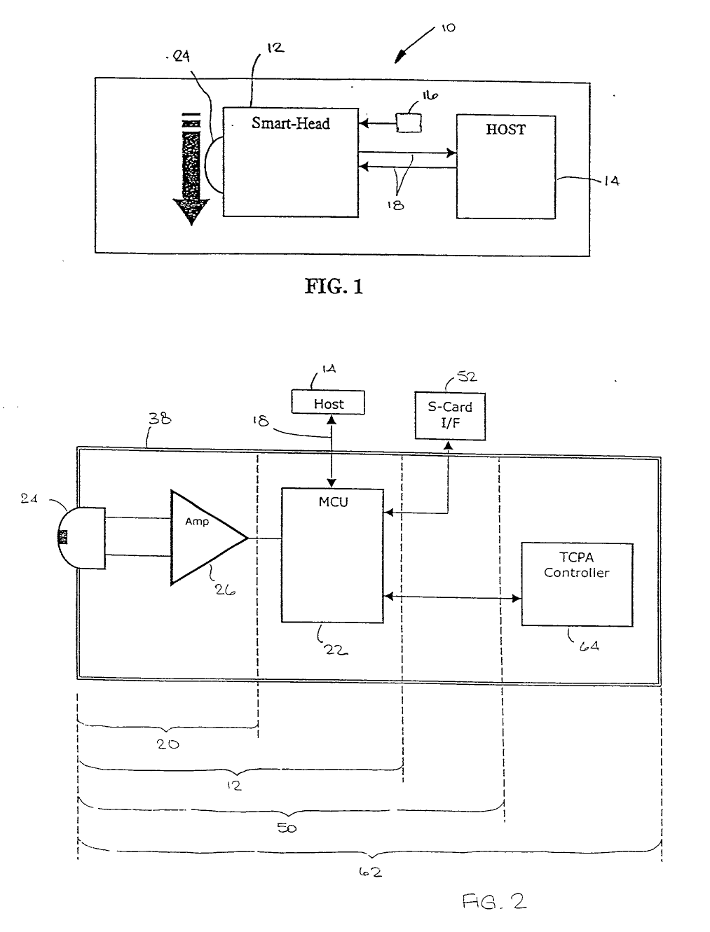

Referring to FIG. 1, a device 10 includes a Smart-Head magnetic stripe reader 12, in accordance with the present invention, and a host 14. Device 10 can be any device, such as a credit card machine or an automated teller machine (ATM), which utilizes information contained on a magnetic stripe. Host 14 is the main CPU of device 10. Device 10 further includes a power source 16, which supplies between 3.3 V to 5 V to power the Smart-Head magnetic stripe reader 12. The Smart-Head magnetic stripe reader 12 communicates with host 14 over an interface 18.

As illustrated in FIG. 2, the Smart-Head magnetic stripe reader 12 includes a magnetic head assembly 20 and a microcontroller 22, which are housed in a mechanical enclosure 38. Magnetic head assembly 20 is connected to microcontroller 22, which processes the information it receives as a result of a magnetic stripe being swiped across magnetic head assembly 20. Microcontroller 22 then transfers the processed information to host 14.

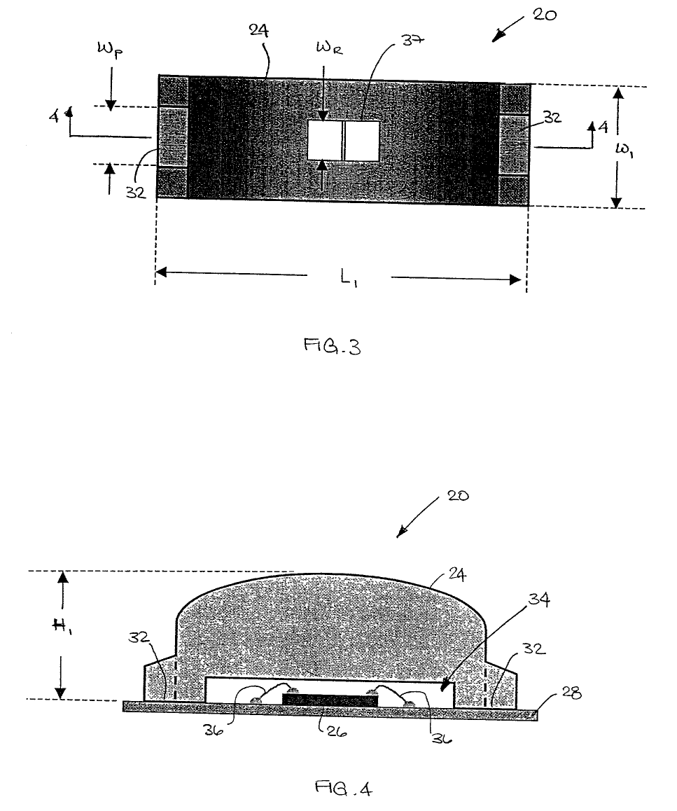

As better illustrated in FIGS. 3 and 4, magnetic head assembly 20 includes a magnetic head 24 and an amplifier 26, both of which are mounted on an MCM substrate 28. MCM substrate 28 includes MCM pads (not shown), and magnetic head 24 includes bond pads 32, each of which is bonded to a respective MCM pad. Any one of a number of commonly used adhesives may used to bond the bond pads 32 of magnetic head 24 to MCM pads of substrate 28. At this time, no specific adhesive is preferred.

Amplifier 26 of magnetic head assembly 20 is provided in chip or die form. The die with the amplifier 26 is encased by magnetic head 24 and MCM substrate 28 and is located in an opening 34 between magnetic head 24 and MCM substrate 28. Amplifier 26 is also electrically connected by bonding wires 36, each extending from a die pad (not shown) to respective MCM pads on MCM substrate 28. Alternative ways of bonding the die to MCM substrate 28 may include flip chip technology or solder bumps.

Magnetic head assembly 20 may be fabricated using any conventional MCM, MCP or other multi-chip manufacturing process to provide a single component or module magnetic head assembly 20. In the alternative, magnetic head assembly 20 may be a chip-on-board printed circuit board (PCB) module. Thus, magnetic head assembly 20 is compact in size. By way of example, magnetic head assembly 20 may have a length L₁ of approximately 10 mm, a width W₁ of approximately 3.5 mm, and a height H₁ of approximately 4 mm. Opening 34 in magnetic head 24 may have a length of approximately 6 mm. A read portion 37 of magnetic head 24 has a width W_{R} of approximately 1.4 mm, and bond pads 32 have a width W_{P} of approximately 1.5 mm.

One advantage of magnetic head assembly 20 is that it provides a high-level analog signal output, as compared to conventional magnetic heads. This is due to the presence of amplifier 26, which increases the low level signal from the magnetic head. Another advantage of the present magnetic head assembly 20 is its improved signal-to-noise characteristics. The close proximity of amplifier 26 to magnetic head 24 reduces interference, thereby significantly improving signal-to-noise characteristics.

Referring back to FIG. 2, magnetic head assembly 20 of the Smart-Head magnetic stripe readers 12 is coupled to microcontroller 22. Microcontroller 22 includes various electronic components (not shown), such as a CPU, flash memory, input and output ports and timers. Microcontroller 20 may be provided on the same die as amplifier 26 or on a separate die. Microcontroller 20 processes the information that it receives via amplifier 26 from magnetic head 24 and transmits that information to host 14.

During operation of the Smart-Head magnetic stripe reader 12, microcontroller 22 communicates with host 14 across interface 18. Interface 18 may be any appropriate interface, such as a universal asynchronous receiver-transmitter (UART), an inter-IC (I2C), or a universal serial bus (USB). Thus, the Smart-Head magnetic stripe reader 12 receives a swiped magnetic stripe as input and converts the information to formatted UART, I2C or USB data stream output, which is then transmitted to host 14.

The Smart-Head magnetic stripe reader 12 is capable of reading the magnetic stripes of standard credit cards as well as those having higher densities, as will be described in greater detail below. Magnetic head 24 of the Smart-Head magnetic stripe reader 12 has a recording density in the range of approximately 70 bits per inch (BPI) to approximately 800 BPI. In addition, the Smart-Head magnetic stripe reader 12 is programmable and can, therefore, be customized by a user or an original equipment manufacturer (OEM). By way of example, for a magnetic stripe reader 12 that interfaces with host 14 using I2C data protocol, the I2C port can be used to load data into the flash memory of microcontroller 22. Thus, OEMs can load their own firmware to customize the Smart-Head magnetic stripe reader 12, such as to incorporate specific algorithms for security purposes.

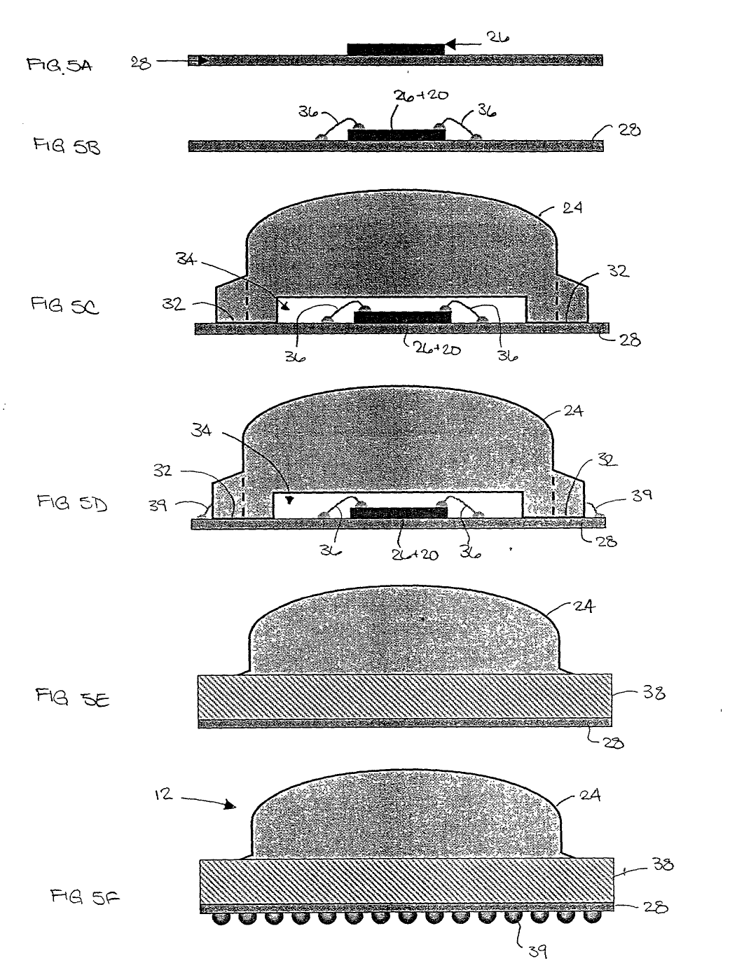

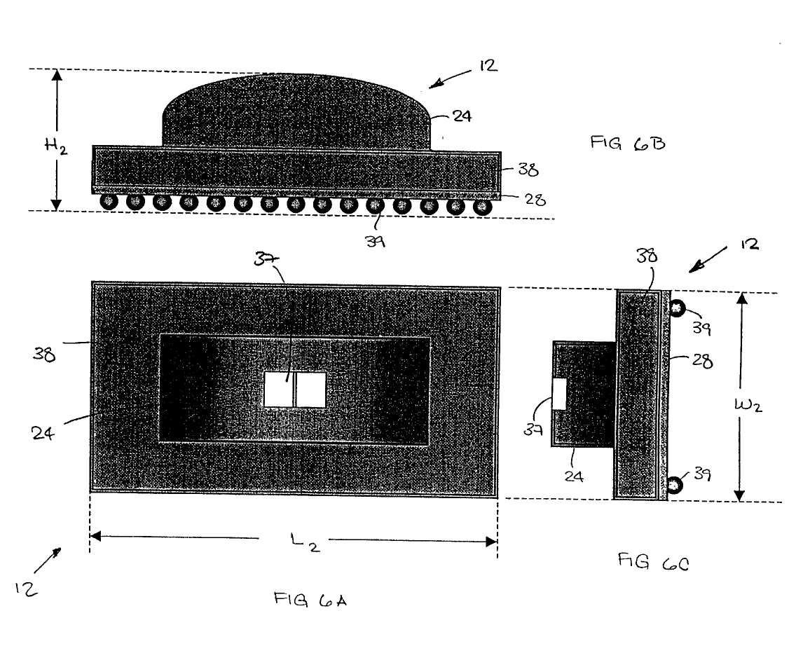

FIGS. 5A-5F illustrate the fabrication process for the Smart-Head magnetic stripe reader 12. In FIG. 5A a die including amplifier 26 and microprocessor 20 is mounted on substrate 28. In FIG. 5B bonding wires 36 are then used to electrically connect the die to the MCM pads of substrate 28.

In FIG. 5C magnetic head 24 is placed over the amplifier and microcontroller die and secured to substrate 28 with an adhesive. In FIG. 5D bonding wires 39 are used to electrically connect magnetic head 24 to the MCM pads of substrate 28.

In FIG. 5E, the assembly is then encapsulated in a mechanical enclosure 38 to provide a single magnetic stripe reader component or module. In FIG. 5F solder balls are added to complete the Smart-Head magnetic stripe reader 12. The Smart-Head magnetic stripe reader 12 may be encapsulated in a ball grid array (BGA) package or a plastic BGA (PBGA) package.

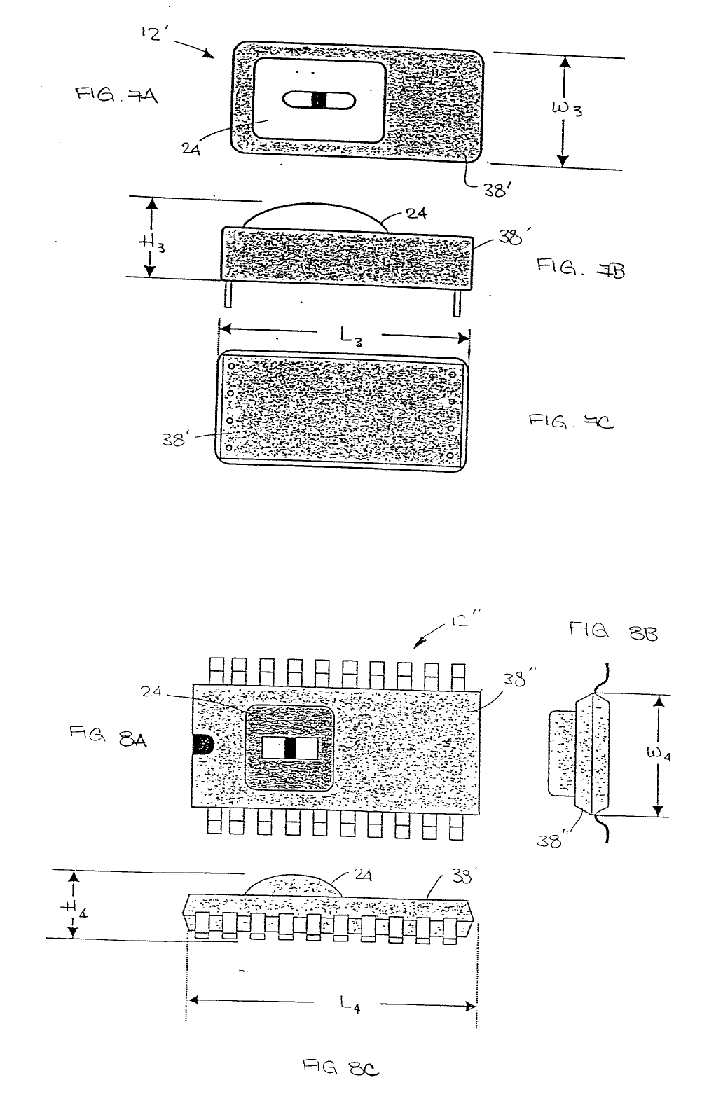

FIGS. 6A-6C provided a top and two side views of the Smart-Head magnetic stripe reader 12 in a PBGA package. Approximate dimensions of this packaged magnetic stripe reader include a length L₂ of 18 mm, a width W₂ of 8 mm and a height H₂ of 5 mm.

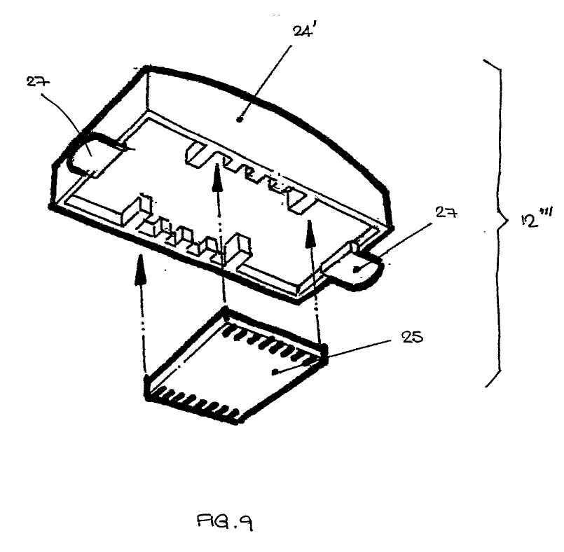

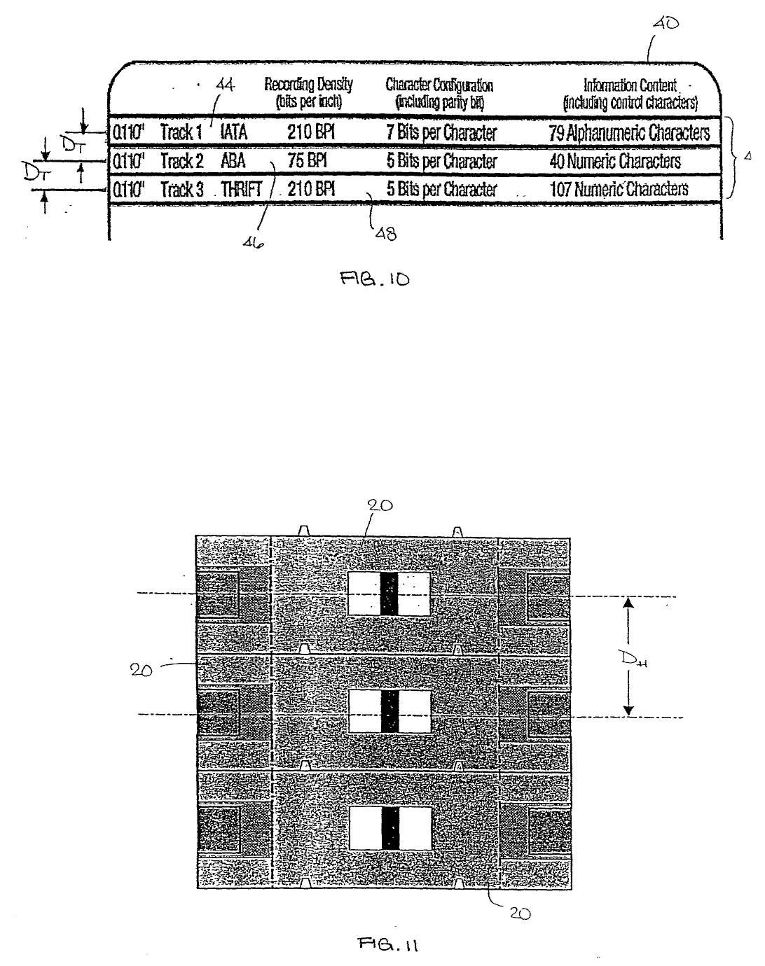

Various other suitable mechanical enclosures may be used to encapsulate the Smart-Head magnetic stripe reader 12, including a dual in-line package (DIP) and a small outline integrated circuit (SOIC). FIGS. 7A-7C illustrate a DIP version 12′ of the Smart-Head magnetic stripe reader with a mechanical enclosure 38′. An exemplary DIP version of the magnetic stripe reader has a length L₃ of approximately 15 mm, a width W₃ of approximately 12 mm, and a height H₃ of approximately 4 mm. FIGS. 8A-8C illustrate a SOIC version 12″ of the Smart-Head magnetic stripe reader with a mechanical enclosure 38″. An exemplary SOIC version of the magnetic stripe reader has a length L₄ of approximately 13 mm, a width W₄ of approximately 7.5 mm, and a height H₄ of approximately 5 mm. The exact dimensions of the Smart-Head magnetic stripe reader 12 will vary depending on the packaging. In addition, even though the Smart-Head magnetic stripe reader 12 is optimized for miniaturization and low power operation, it may be used in larger devices, such as ATMs, in place of a conventional magnetic card reader.

While the above-described embodiments disclose the Smart-Head magnetic stripe readers 12, 12′ and 12″ packaged in mechanical enclosure 38, 38′ and 38″, respectively, one of ordinary skill in the art will appreciate that a Smart-Head magnetic stripe reader may also be provided without such a mechanical enclosure. FIG. 9 illustrates a Smart-Head magnetic stripe reader 12′″ according to an alternative embodiment of the present invention. This Smart-Head magnetic stripe reader 12′″ lacks the MCM packaging discussed above with respect to previous embodiments. Instead, a magnetic head 24′ of the magnetic stripe reader 12′″ is designed to receive and to house an application specific integrated circuit (ASIC) chip 25, which includes the amplifier and microcontroller discussed above. ASIC chip 25 may be snugly inserted into the housing of magnetic head 24′ and secured in place with an adhesive (not shown). Magnetic head 24′ is a surface mount technology (SMT) part that has pins 27. Magnetic head 24′ and ASIC chip 25 are not electrically connected together until the assembly is mounted using standard SMT techniques onto a printed circuit board of the device. Like the above described Smart-Head magnetic stripe readers 12, 12′ and 12″, Smart-Head magnetic stripe reader 12′″ is compact in size. In addition, since the Smart-Head magnetic stripe reader 12′″ has fewer components, it may be faster and cheaper to assemble into a device.

The Smart-Head magnetic stripe readers described above have only one magnetic head assembly 20; however, multiple magnetic head assemblies may also be provided in the Smart-Head magnetic stripe reader 12 to read multi-track magnetic stripes, such as that shown in FIG. 10. FIG. 10 illustrates a card 40 having a multi-track magnetic stripe 42. In particular, magnetic stripe 42 includes a first track 44 containing International Air Transport Association (IATA) information, a second track 46 containing American Bankers Association (ABA) information, and a third track 48 containing Thrift (e.g, savings and loans, and credit unions) information. A distance D_{T} between the center of second track 46 and the center of either first track 44 or third track 48 is approximately between 3.3 mm and 3.6 mm.

FIG. 11 illustrates three identical magnetic head assemblies 20 that have been stacked together to read multi-track magnetic stripe 42 of FIG. 10. When magnetic head assemblies 20 are stacked together, a distance D_{H} between the center axes of two adjacent magnetic head assemblies is approximately equal to distance D_{T} between adjacent tracks 44, 46 and 48 of multi-track track magnetic stripe 42. By way of example, distance D_{H} may be approximately 3.5 mm. Since the present invention uses the same magnetic head assembly for a single-track magnetic stripe reader as for a multi-track magnetic stripe reader, no separate tooling is required to fabricate a two-track or a three-track magnetic stripe reader.

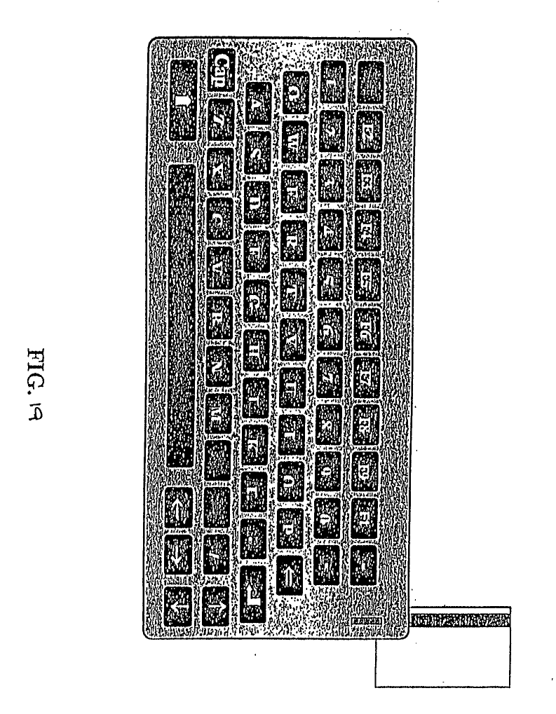

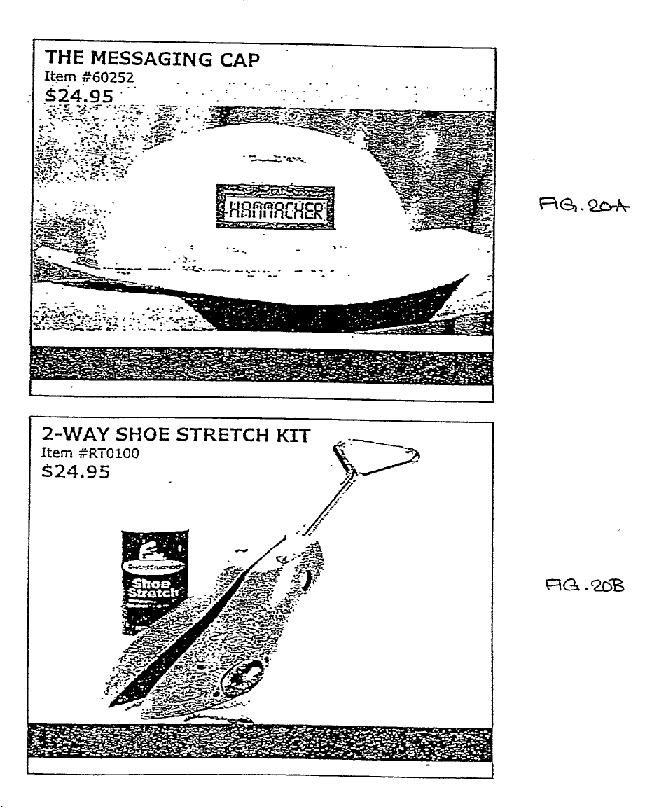

As discussed above, the Smart-Head magnetic stripe reader 12 utilizes MCM, MCP or any other multi-chip components to provide a single component or module magnetic stripe reader. The Smart-Head magnetic stripe reader 12 includes a fully functional magnetic reader, an electronic circuit, decoding firmware, in a mechanical enclosure fabricated using DIP or SMT. In addition, the Smart-Head magnetic stripe reader 12 includes infrastructure support for loading firmware into the reader. The Smart-Head magnetic stripe reader 12 has a single low profile and requires little power, which makes it well-suited for use in portable device applications. FIGS. 18A-18C illustrate a PDA, a cellular phone, and a web-pad, respectively, as examples of devices that can include the Smart-Head magnetic stripe reader 12. The Smart-Head magnetic stripe reader 12 may also be provided in a keyboard, as illustrated in FIG. 19. The Smart-Head magnetic stripe reader 12 also eliminates the complexities of magnetic stripe reading and decoding, and improves noise immunity and signal integrity.

One extension of the Smart-Head magnetic stripe reader 12 is a Combo-Reader magnetic stripe reader 50. Referring back to FIG. 2, the Combo-Reader magnetic stripe reader 50 includes a smart card reader, in addition to all of the features of the Smart-Head magnetic stripe reader 12, thereby providing a compact, universal component that addresses the needs of both the magnetic-encoded card and smart card markets.

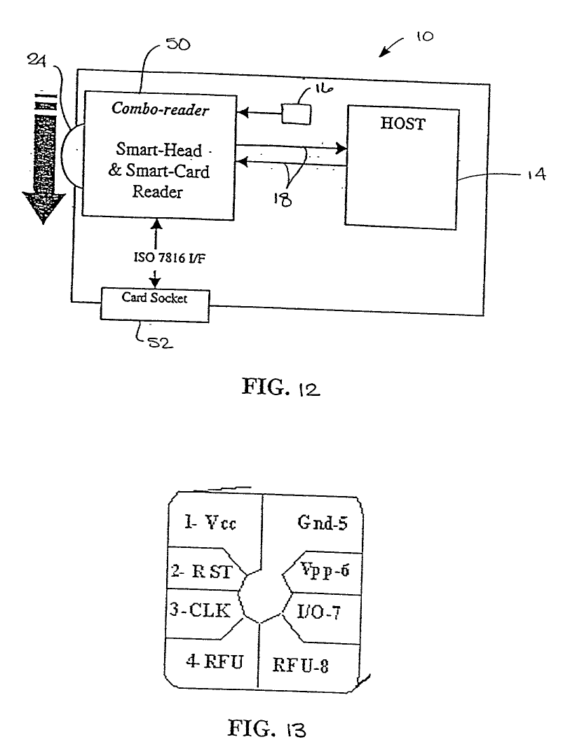

FIG. 12 illustrates the Combo-Reader magnetic stripe reader 50 incorporated into device 10 and in communication with host 14. Device 10 further includes a card socket 52 for presenting a smart card to the Combo-Reader magnetic stripe reader 50. Card socket 52 communicates with the reader 50 via an ISO 7816 serial interface.

In order to convert the Smart-Head magnetic stripe reader 12 into a Combo-Reader magnetic stripe reader 50, additional electronic circuitry is added to the microcontroller 22. In particular, an ISO 7816 serial interface and special firmware for processing smart card data are added to the microcontroller 22. Input terminals for the five interface signals listed in Table 1 must be added to provide the ISO 7816 serial interface connection (see FIG. 12), so that the Combo-Reader magnetic stripe reader 50 will process data from a smart card. The smart card has an ISO 7816-2 pin arrangement, as illustrated in FIG. 13. The firmware that is added to the microcontroller 22 will translate data from the ISO 7816 serial interface to and from the UART or USB host protocol.

TABLE 1
ISO 7816 interface signals

| Name | I/O | Contact | Description |
|---|---|---|---|
| PRES # | I | NA | Card Present signal |
| VCC | O | C1 | Card power, controlled by MCU via FET |
| RST | O | C2 | Card reset |
| CLK | O | C3 | Card clock |
| I/O | I/O | C7 | Card data I/O |

The Combo-Reader magnetic stripe reader 50 is packed in a mechanical enclosure 38 just as is the Smart-Head magnetic stripe reader 12. Since no additional parts are added to the Smart-Head magnetic stripe reader 12 to produce the Combo-Reader magnetic stripe reader 50, the Combo-Reader magnetic stripe reader 50 has similar dimensions to the Smart-Head magnetic stripe reader 12.

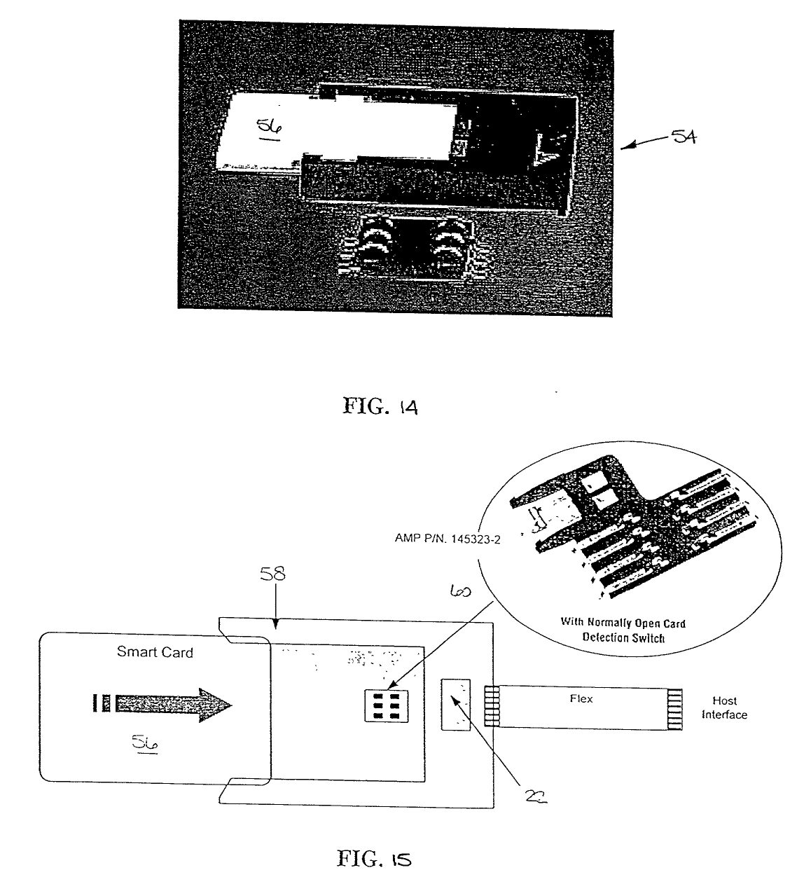

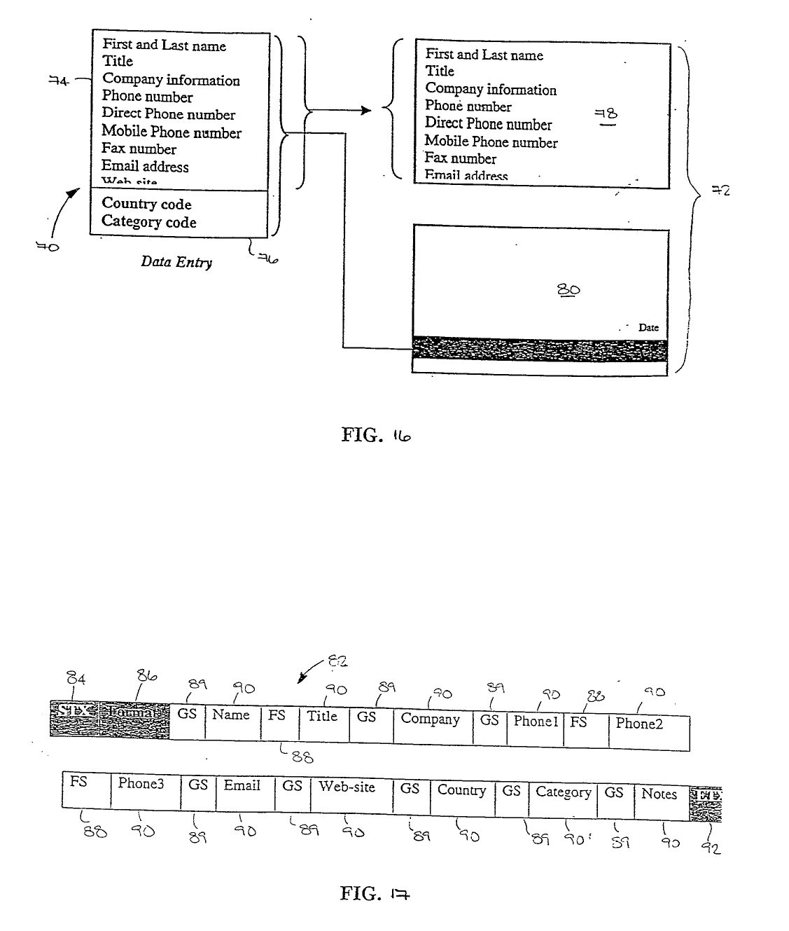

FIG. 14 is a perspective view of a typical smart card connector assembly 54 with a smart card 56 received therein. FIG. 15 shows one embodiment of a subscriber identity module (SIM) reader 58. The SIM reader 58 integrates the connector assembly and associated electronics in an enclosure and can host a UART or USB interface. The SIM reader 58 includes a connector pin 60 with a card detection switch that is normally open, in the absence of a smart card.

Referring back to FIG. 2, a further extension of either the Smart-Head magnetic stripe reader 12 or the Combo-Reader magnetic stripe reader 50 is a TCPA magnetic stripe reader 62. The TCPA magnetic stripe reader 62 includes a TCPA controller 64, which provides the reader 62 with embedded security functionality and improved control of access to data. The controller 64 may be any TCPA-compliant device. One such TCPA-compliant device is the SLF9630C T rusted Platform Module by Infineon. The TCPA controller 64 may be provided on the same die as amplifier 26 and/or microcontroller 22, or they may all be provided on separate die. The TCPA magnetic stripe reader 62 is encased in the same type of mechanical enclosure 38 as the Smart-Head and Combo-Reader magnetic stripe readers 12 and 50, respectively.

The present invention enables any one of the Smart-Head, Combo-Reader or TCPA magnetic stripe reader 12, 50 and 62, respectively, to be incorporated into a portable device, thereby expanding the use of MSM and/or smart cards. For example, incorporation of the Smart-Head magnetic stripe reader 12 into a PDA may facilitate the use of eBiz-cards (e.g., business cards with a magnetic stripe containing the information printed on the business card). Information on these eBiz-cards may be stored in and managed by a web-based depository.

Operation of a web-based depository to manage the eBiz-card information will now be described. In order to obtain an eBiz-card, a user would first log onto the web-based depository's site, which may be named BizCardMining com, using a previously created password. The password is a security mechanism, which restricts access to the site to protect users'personal information.

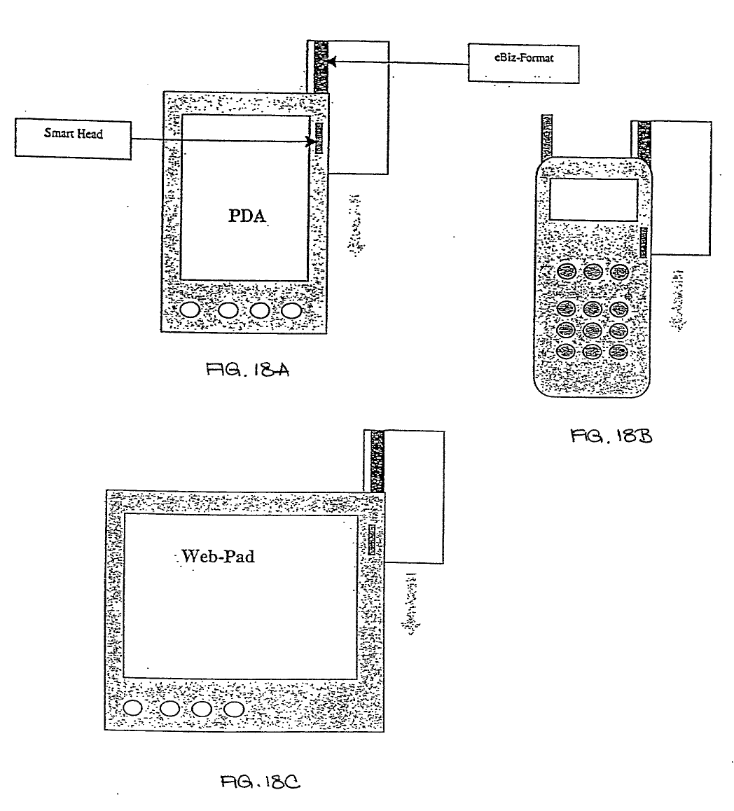

The user will then enter various information, such as name, address, telephone and fax numbers, or any other type of information, when prompted by the system. A partial list of the relevant fields, which the user enters for the eBiz-card, is illustrated by reference numeral 70 in FIG. 16. Once the user has entered all of the information, the system will assign the user an account number. The account number may be used to retrieve the user's profile at a later date.

In order to protect the privacy of the user, the system will then request permission to make the user's information publicly available. The user may choose to allow all, some or none of his/her information to be released to the public. Those fields that the user chooses to make public will be listed in a public depository at the site.

After entering the requested information, the user selects an eBiz-card provider from a list of providers. The eBiz-card provider will then print out the user's eBiz-cards. The eBiz-card may be printed by existing paper printers. The user must work directly with the eBiz-card provider as to any artwork and design layout of the eBiz-card. The information supplied by the web-site only enables the printer to retrieve the information that the user entered at the web-site. A web-based system will be developed to link an eBiz-card order entry with plain paper printers. For example, BizCardMining.com will encode the user's information into a special eBiz-format and send the formatted information electronically to the card printer. The user's account number will be used as a cross-reference.

The web-based depository makes it very easy and convenient for a user to edit and reorder eBiz-cards, since all of the relevant information is stored electronically. When a user wishes to update any user information or reorder more eBiz-cards, the user logs onto the BizCardMining.com site and enters his password and account number. The system will retrieve and display the user's previously entered information.

The user can then select between “REORDER” and “EDIT” options. If “REORDER” is selected, the system will prompt the user until the order is submitted. If “EDIT” is selected, the system will permit the user to change any of the previously entered information. However, if the user wishes to change the graphics printed on the eBiz-card, the user must coordinate directly with the eBiz-card provider. Once the user completes the edit session, he will have the option to order new eBiz-cards. The edit session also provides the user the capability to change whether any information is provided to the public or should be kept private.

Referring back to FIG. 16, the relationship between the user data entry and a resulting eBiz-card 72 is shown. The data entry block 70 includes two distinct fields, a text field 74 and a special code field 76. The text field 74 contains printable fields, such as the user's first and last name, title, company information, and telephone numbers. The text field 74 includes a notes section (not shown), which allows the user to customize the eBiz-card by adding a brief statement describing his/her specialty area and products. Further, if the user's company does not have a web-site, the user can request that the BizCardMining.com web-site be added to the eBiz-card. The company can then post an advertisement at the BizCardMining.com web-site. Then, when a user swipes that eBiz-card to enter the information into a PDA or other device, the PDA may retrieve the company's advertisement on BizCardMining.com web-site.

The special code field 76 includes country and category codes. The country code will use the standard telephone country codes conventions. The category code will identify the industry category (e.g., electronics, pharmaceutical, etc.).

The text field 74 and the special code field 76 are then encoded into a special eBiz-card format 82, which is illustrated in FIG. 17. The formatted information is then magnetically written into the magnetic stripe on the back 80 of the eBiz-card (FIG. 16). Information from the text field 74 is also printed on the front 78 of the eBiz-card. As discussed above, the actual layout and design and any logo on the eBiz-card will be handled directly by the user and the eBiz-card provider.

In order to accommodate all of the information listed above, a magnetic stripe for an eBiz-card should be able to store at least between 260 and 300 bytes. A breakdown of the storage space by data entry field is listed in Table 2. Standard ASCII, ANSI-X3.4-1986 will be used to store the information. As illustrated in FIG. 17, the data stream format 82 will start with a start-of-text (STX) character 84, followed by a format code 86. One ASCII character will be used for the format code 86. Special control bytes will be used as field separators 88 and group separators 89 to delineate the text fields 90. The end of the data stream format 82 will consist of an end-of-text (ETX) character 92. To further save space, unique words, such as “com” and “www,” will be assigned a single byte code (e.g., D1=com, D2=www, etc.) and abbreviations will be stored (e.g., VP for Vice President).

TABLE 2
Estimated byte count

| Field | Bytes |
|---|---|
| First and Last Name | 20 |
| Title | 30 |
| Company Information | 50 |
| Phone number | 12 |
| Direct Phone number | 12 |
| Mobile Phone number | 12 |
| Fax number | 12 |
| Email address | 25 |
| Web-site | 25 |
| Country code | 3 |
| Category code | 3 |
| Notes | 40 |
| Control codes | 16 |
| Total | 260 |

In addition to providing users with the ability to order eBiz-cards, the system can use the database information to create a yellow pages directory that can be accessed by the public. Most of the information listed on the eBiz-card is of the type that a user would likely disseminate to the public anyway (e.g., company name, address and telephone number). As the number of eBiz-card users grows, the directory will contain more specific information that can be searched using the Internet. Further, the yellow pages directory will be automatically updated, when a user updates his/her eBiz-card information. Thus, users will not have to wait until a subsequent printed edition is published before their current information is disseminated to the public. Each entry may include a date stamp, indicating when the information was last updated.

Management for the encoding rights to paper base printers will be established to enable them to manufacture eBiz-Card. Since the depository will have a vast database of up-to-date information, this data may be sold to other companies. However, to protect the privacy rights of the user, the user will have the right to withhold the information entered into the web-site from reaching the public domain.

As discussed earlier, the Smart-Head magnetic stripe reader 12 can be incorporated into a keyboard (FIG. 19) or a portable device (FIGS. 18A-18C) so as to input data from an eBiz-card directly into the device. In addition, if the cellular phone in FIG. 18B has the ability to read eBiz-cards, a user could swipe an eBiz-card, perhaps from a restaurant, to have the phone automatically dial the restaurant.

The Smart-Head magnetic stripe reader 12 also enables the use of other magnetic-paper media. One such application is for mail inserts and catalogs. As illustrated in FIGS. 20A and 20B, mail inserts or catalogs with advertisements can be printed on perforated paper with magnetic stripes. Each advertisement would have a magnetic stripe containing information about the product being sold. A consumer can detach the selected advertisement and swipe its magnetic stripe across the Smart-Head magnetic stripe reader, which is located in a device that is connected to the Internet. This swiping action will automatically link the user to the catalog web-site, display all of the relevant information about the product, such as product and item number, and then direct the user to a “checkout” page. If the consumer wishes to purchase the product, the consumer may then swipe a credit card across the reader to purchase the product. It should be noted that although the above-described example uses the Smart-Head magnetic stripe reader, the same example would also work with either the Combo-Reader or TCPA magnetic stripe reader.

The foregoing description of preferred embodiments of the present invention are illustrative only and are not intended to be exhaustive or to limit the invention to the precise forms disclosed. Obviously, many modifications and variations will be apparent to those skilled in the art. The embodiments were chosen and described in order to best explain the principles of the invention and its practical application, thereby enabling others skilled in the art to understand various embodiments of the invention, and various modifications that are suited to the particular use contemplated. The scope of the invention is defined by the following claims.

What is claimed is:

1. A magnetic head assembly comprising:
a magnetic head including a housing having an opening formed therein; and
a chip disposed in the opening of the housing, the chip including an amplifier.

2. The magnetic head assembly of claim 1, wherein the magnetic head has a recording density in the range of approximately 70 to 800 bits per inch.

3. The magnetic head assembly of claim 1, wherein the chip is bonded to the housing of the magnetic head.

4. The magnetic head assembly of claim 1, further comprising a multi-chip module substrate including a first bonding pad and a second bonding pad, and wherein the magnetic head includes a first bond pad and a second bond pad, the first and second bond pads being electrically connected to the respective first and second bonding pads of the substrate, the chip being mounted on the substrate and connected by bonding wires to the first and second bonding pads of the substrate.

5. An improved magnetic stripe reader comprising:
a magnetic head including a housing having an opening formed therein;
a chip disposed in the housing of the magnetic head, the chip including an amplifier and a microcontroller, the microcontroller containing electronic circuitry for processing information from a magnetic stripe, the microcontroller receiving information from the magnetic head via the amplifier and transmitting the information to a host.

6. The magnetic stripe reader of claim 5, wherein the magnetic head has a recording density in the range of approximately 70 to approximately 800 bits per inch.

7. The magnetic stripe reader of claim 5, wherein the chip is bonded to the housing of the magnetic head.

8. The magnetic stripe reader of claim 5, wherein the chip is an ASIC chip.

9. The magnetic stripe reader of claim 5, further comprising a multi-chip module substrate including at least a first bonding pad and a second bonding pad, and wherein the magnetic head and the chip are mounted on the substrate and electrically connected to the first and second bonding pads.

10. The magnetic stripe reader of claim 9, further comprising a mechanical enclosure encasing the magnetic head and the chip to form a single module.

11. The magnetic stripe reader of claim 10, wherein the mechanical enclosure is any one of a DIP and a SOIC package.

12. The magnetic stripe reader of claim 9, wherein the magnetic head and the chip are assembled on the substrate using any one of an MCM, MCP, and chip-on-board manufacturing process.

13. The magnetic stripe reader of claim 5, wherein the microcontroller interfaces with the host via any one of a USB, UART, I2C, and SPI protocol.

14. The magnetic stripe reader of claim 5, wherein a plurality of magnetic heads are located adjacent to each other, each magnetic head for reading a track of a multi-track magnetic stripe.

15. The magnetic stripe reader of claim 5, wherein the microcontroller further includes electronic circuitry for interfacing with and processing information from a smart card.

16. The magnetic stripe reader of claim 15, wherein the electronic circuitry for interfacing with and processing information from the smart card includes an ISO 7816 serial interface.

17. The magnetic stripe reader of claim 16, further comprising a TCPA-compliant controller electrically connected to the microcontroller.

18. A device for reading information from a magnetic stripe, the device comprising:
a printed circuit board; and
a magnetic stripe reader assembly mounted to the printed circuit board, the assembly comprising:
a magnetic head including a housing having an opening formed therein; and
a chip disposed in the opening of the housing, the chip including an amplifier and a microcontroller, the microcontroller containing electronic circuitry from processing information from the magnetic stripe, the microcontroller receiving information from the magnetic head via the amplifier and transmitting the information to a host.

19. The device of claim 18, wherein the magnetic head has a recording density in the range of approximately 70 to approximately 800 bits per inch.

20. The device of claim 18, wherein the chip is an ASIC chip.

21. The device of claim 18, wherein the magnetic stripe reader assembly further comprises:
a multi-chip module substrate including at least a first bonding pad and a second bonding pad, the magnetic head and the chip being mounted on the substrate and electrically connected to the first and second bonding pads of the substrate; and
a mechanical enclosure encasing the magnetic head and the chip to form a single module.

22. The device of claim 20, wherein the magnetic head and the chip are assembled on the substrate using any one of an MCM, MCP, and chip-on-board manufacturing process.

23. The device of claim 18, wherein the magnetic stripe reader assembly includes a plurality of magnetic heads adjacent to each other, each magnetic head for reading a track of a multi-track magnetic stripe.

24. The device of claim 18, wherein the microcontroller further includes electronic circuitry for interfacing with and processing information from a smart card.

25. The device of claim 24, wherein the electronic circuitry for interfacing with and processing information from the smart card includes an ISO 7816 serial interface.

26. The device of claim 24, farther comprising a TCPA-compliant controller electrically connected to the microcontroller.

27. A data format for encoding information on a business card for a magnetic stripe, the data format comprising:
a start-of-text character and an end-of-text character identifying a respective start and an end of the business card information;
a format code located after the start-of-text character;
a plurality of text fields located between the start-of-text character and the end-of-text character, the text fields including information on the business card; and
a plurality of group separators and a plurality of field separators, the field and group separators being located between the start-of-text character and the end-of-text character and separating the plurality of text fields.

28. The data format of claim 27, wherein the information on the business card included in the plurality of text fields includes a first and last name, a title, a company and address, at least one phone number, and a fax number.

29. The data format of claim 28, wherein the information on the business card included in the plurality of text fields further includes an electronic mail address and a web-site.

30. The data format of claim 28, wherein the information on the business card included in the plurality of text fields further includes a country code and a category code.

31. The data format of claim 27, wherein the data format includes between approximately 260 and approximately 300 bytes.

32. A method of creating a business card comprising:
accessing a depository over a network;
entering information into the depository, the information including a first and last name, a title, a company and address, at least one phone number, and a fax number;
storing the information in the depository;
formatting the information in an electronic format; and
printing a business card, a front of the business card having the information printed thereon, a back of the business card including a magnetic stripe containing the information printed on the business card in the electronic format.

33. The method of claim 32, wherein the information further includes an electronic mail address and a web-site.

34. The method of claim 33, wherein the information further includes a country code and a category code.

35. The method of claim 33, further comprising updating the information stored in the depository.

36. A method of selling a product to a consumer, the method comprising:
distributing a medium having a description of the product, the medium further including a magnetic stripe;
having the consumer swipe the magnetic stripe of the medium across a magnetic stripe reader, the magnetic stripe reader being located in a device that is connected to a network, wherein swiping the magnetic stripe of the medium retrieves a site containing information about the product; and
having the consumer swipe a magnetic stripe of a financial card across the magnetic stripe reader to purchase the product.
